(19) United States
(12) Patent Application Publication
(10) Pub. No.: US 2012/0134722 A1
(43) Pub. Date: May 31, 2012

(54) DEVELOPING DEVICE AND IMAGE FORMING APPARATUS

(75) Inventors: Takuya SASAKI, Toyokawa-shi (JP); Takayuki Takai, Anjo-shi (JP); Takuya Okada, Toyokawa-shi (JP); Hokuto Hatano, Toyokawa-shi (JP)

(73) Assignee: Konica Minolta Business Technologies, Inc., Chiyoda-ku (JP)

(21) Appl. No.: 13/299,838

(22) Filed: Nov. 18, 2011

(30) Foreign Application Priority Data
Nov. 25, 2010 (JP) 2010-262297

(51) Int. Cl. G03G 15/09

(52) U.S. Cl. 399/269; 399/270

(57) ABSTRACT

A developing device having: a plurality of toner support members for supporting toner on their peripheral surfaces, the plurality of toner support members being arranged in a direction of rotation of an image support member out of contact with the image support member; and a developer support member for supporting a developer containing toner and carriers and supplying the toner to the plurality of toner support members; wherein the plurality of toner support members have dielectric layers on their surfaces, the dielectric layers satisfying a condition d1/∈1>d2/∈2; and wherein the first toner support member and the second toner support member are connected to a single power source.

This application is based on Japanese Patent Application No. 2010-262297 filed on Nov. 25, 2010, of which content is incorporated herein by reference.

### BACKGROUND OF THE INVENTION

1. Field of the Invention

The present invention relates to a developing device, and more particularly to a developing device used for an electrophotographic process, that is, a developing device for developing an electrostatic latent image formed on a photoreceptor, and an image forming apparatus provided with the developing device.

2. Description of Related Art

In the field of electrophotographic image forming, recently, hybrid development attracts attention. The hybrid development has both the advantages of one-component development using a one-component developer containing only toner and the advantages of two-component development using a two-component developer containing toner and carriers stirred and mixed together. In the hybrid development, the toner and the carriers in the two-component developer are stirred and mixed together so that the toner is charged, and an electric field is formed between a developer support roller that supports the two-component developer and a developing roller for supplying the toner to the photoreceptor. Then, the toner in the two-component developer is separated from the carriers by the effect of the electric field, and only the toner is supported on the developing roller and supplied to the photoreceptor so that the electrostatic latent image on the photoreceptor can be subjected to one-component development.

In the hybrid development, the magnetic brush does not come into contact with the formed toner image, thereby reducing image noise, compared with in the two-component development. Also, the toner has less stress in the hybrid development, which leads to a higher picture quality and a longer life of toner (see Japanese Patent Laid-Open Publication No. 2-221978). In the hybrid development, however, the developing efficiency is not sufficient for high-speed development that has been demanded for recent years. Using the hybrid development for high-speed development will cause a problem of low reproducibility of thin lines and fine dots. The grade of reproducibility of fine dots stands out especially in thin image areas with small quantities of toner deposited thereon.

In order to solve this problem, providing a plurality of developing rollers is suggested. The use of a plurality of developing rollers will improve the development efficiency, which will result in an improvement in the reproducibility of thin lines and fine dots. In this case, in order to simplify the structure of the electric power source, it is preferable that bias voltages are applied to the plurality of developing rollers from a single electric power source. However, since it is inevitable that the quantities of toner supplied from the developer support roller to the respective developing rollers vary, density unevenness and fogging are seen in the formed image.

### SUMMARY OF THE INVENTION

According to a first aspect of the present invention, a developing device comprising: a plurality of toner support members for supporting toner on their peripheral surfaces, the plurality of toner support members being arranged in a direction of rotation of an image support member out of contact with the image support member and including a first toner support member and a second toner support member that are located upstream and downstream, respectively, from each other with respect to the direction of rotation of the image support member; and a developer support member for supporting a developer containing toner and carriers and supplying the toner to the plurality of toner support members; wherein by effects of electric fields generated by potential differences between an electrostatic latent image formed on the image support member and developing biases applied to the respective toner support members, the toner supported on the plurality of toner support members moves onto the electrostatic latent image; wherein the plurality of toner support members have dielectric layers on their surfaces, the dielectric layers satisfying a condition d1/∈1>d2/∈2, wherein the dielectric layer on the surface of the first toner support member located upstream with respect to the direction of rotation of the image support member has a relative permittivity of ∈1 and a thickness of d1, and the dielectric layer on the surface of the second toner support member located downstream with respect to the direction of rotation of the image support member has a relative permittivity of ∈2 and a thickness of d2; and wherein the first toner support member and the second toner support member are connected to a single power source.

According to a second aspect of the present invention, an image forming apparatus comprising: an image support member; a charger for charging a surface of the image support member; an exposure device for irradiating the surface of the image support member with light to form an electrostatic latent image on the surface of the image support member; and a developing device comprising: a plurality of toner support members for supporting toner on their peripheral surfaces, the plurality of toner support members being arranged in a direction of rotation of the image support member out of contact with the image support member and including a first toner support member and a second toner support member that are located upstream and downstream, respectively, from each other with respect to the direction of rotation of the image support member; a developer support member for supporting a developer containing toner and carriers and supplying the toner to the plurality of toner support members; wherein by effects of electric fields generated by potential differences between the electrostatic latent image formed on the image support member and developing biases applied to the plurality of toner support members, the toner supported on the plurality of toner support members moves onto the electrostatic latent image; wherein the plurality of toner support members have dielectric layers on their surfaces, the dielectric layers satisfying a condition d1/∈1>d2/∈2, wherein the dielectric layer on the surface of the first toner support member located upstream with respect to the direction of rotation of the image support member has a relative permittivity of ∈1 and a thickness of d1, and the dielectric layer on the surface of the second toner support member located downstream with respect to the direction of rotation of the image support member has a relative permittivity of ∈2 and a thickness of d2; and wherein the first toner supply member and the second toner supply member are connected to a single power source.

### BRIEF DESCRIPTION OF THE DRAWINGS

This and other objects and features of the present invention will be apparent from the following description with reference to the accompanying drawings, in which:

FIG. 1 is a sectional view of an image forming apparatus provided with a developing device according to an embodiment of the present invention.

### DETAILED DESCRIPTION OF THE PREFERRED EMBODIMENTS

A developing device and an image forming apparatus according to embodiments of the present invention are hereinafter described with reference to the accompanying drawings.

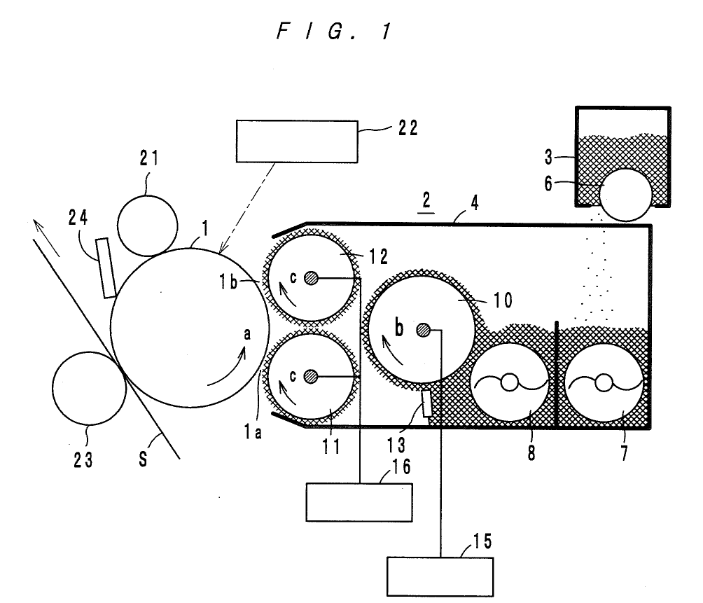

As shown by FIG. 1, a developing device 2 according to an embodiment of the present invention is to develop an electrostatic latent image formed on a photoreceptor (image support member) 1 into a visible image. While the photoreceptor 1 is rotating counterclockwise as shown by arrow a, the photoreceptor 1 is charged by a charging roller 21 to gain a specified electric potential, is scanned with a laser beam emitted from a laser scanning device 22 to obtain an electrostatic latent image thereon, is subjected to development performed by the developing device 22, and is subjected to image transfer therefrom to a recording sheet S by the effect of a transfer electric field applied from a transfer roller 23. Thereafter, the photoreceptor 1 is cleaned by a cleaner 24 so that residual toner can be removed therefrom. Such an electrophotographic process is well known, and a detailed description thereof is omitted.

The charging roller 21 for charging the photoreceptor 1 and the transfer roller 23 for applying the transfer electric field may be replaced with corotoron or scorotoron chargers, and the laser scanning device 22 may use not only laser but also any other type of light.

The developing device 2 comprises a toner bottle 3, a developer tank 4 in which a developer composed of toner and carriers is contained, a developer support roller 10 for supporting a developer on its peripheral surface and feeding the developer in the direction of its rotation (the direction shown by arrow b), a first and a second developing (toner support) roller 11 and 12 for attracting the toner from the peripheral surface of the developer support roller 10 to their own peripheral surfaces and feeding the toner in the directions of their rotations (the direction shown by arrows c). The developing device 2 performs hybrid development. A high-voltage power supply circuit 15 is connected to the developer support roller 10, and a high-voltage power supply circuit 16 is connected to the first and the second developing rollers 11 and 12.

The toner is replenished from the toner bottle 3 into the developer tank 4 by a specified amount at a time with rotation of a toner supply roller 6. At the bottom part of the developer tank 4, stirring/feeding rollers 7 and 8 are provided. The supplied toner is stirred and mixed with carriers with rotations of the stirring/feeding rollers 7 and 8. The stirring/feeding of the developer by use of the stirring/feeding rollers 7 and 8 is performed in the same way as in conventional developing devices, and a description thereof is omitted. The toner bottle 3 may be a separate body from the developing device 2.

The developer support roller 10 is composed of a sleeve driven to rotate in the direction shown by arrow b and a magnetic roller (not shown) fixed inside the sleeve. The developer fed to the vicinity of the developer support roller 10 by the stirring/carrying roller 8 is attracted to the peripheral surface of the sleeve by the effect of the magnetic force of the magnetic roller, and the thickness of the toner on the peripheral surface of the sleeve is regulated by the blade 13. Then, the toner is fed to between the first and the second developing rollers 11 and 12. The first developing roller 11 is located upstream with respect to the direction of rotation of the photoreceptor 1 (the direction shown by arrow a), and is driven to rotate clockwise (in the direction shown by arrow c). The second developing roller 12 is located downstream with respect to the direction of rotation of the photoreceptor 1, and is driven to rotate clockwise (in the direction shown by arrow c).

In the area where the developer support roller 10 faces to the first and the second developing rollers 11 and 12, electric fields are generated by the high-voltage power supply circuits 15 and 16 so as to cause the toner to separate from the carriers and to move to the peripheral surfaces of the rollers 11 and 12.

The toner supported on the first developing roller 11 is fed to a developing area 1a where the first developing roller 11 faces to the photoreceptor 1 with rotation of the developing roller 11. An electric field is generated by the potential difference between the electrostatic latent image formed on the photoreceptor 1 and an AC bias superimposed with a DC voltage applied to the developing roller 11 from the high-voltage power supply circuit 16. By the effect of the electric field, the toner reciprocates between the developing roller 11 and the photoreceptor 1, thereby developing the electrostatic latent image. Also, the toner supported on the second developing roller 12 is fed to a developing area 1b where the second developing roller 12 faces to the photoreceptor 1 with rotation of the developing roller 12. An electric field is generated by the potential difference between the electrostatic latent image formed on the photoreceptor 1 and an AC bias superimposed with a DC voltage applied to the developing roller 12 from the high-voltage power supply circuit 16. By the effect of the electric field, the toner reciprocates between the developing roller 12 and the photoreceptor 1, thereby developing the electrostatic latent image.

Thus, the developer supply roller 10 separates the toner from the developer supported on its peripheral surface and feeds only the toner to the developing rollers 11 and 12. Also, after the toner reciprocates in the developing areas 1a and 1b, the developer supply roller 10 collects the toner remained on the developing rollers 11 and 12, and further, the developer supply roller 10 returns the toner collected from the developing rollers 11 and 12 to the stirring/feeding roller 8.

For the developer that is a mixture of toner and carriers, a commonly used material that is prepared by adding a coloring agent, a charge control material, a mold release agent and other agents, if necessary, to binder resin can be used as the toner. It is preferable that the toner particles have a diameter within the range from 3 μm to 15 μm. As the carriers, commonly used carriers of a binder type or a coat type can be used. It is preferable that the carriers have a diameter within the range from 15 μm to 100 μm. The mixing ratio of toner and carriers is set so that a desirable toner charge can be attained. Specifically, the percentage of toner to the total of toner and carriers is within the range from 3 wt % to 50 wt %, and preferably within the range from 6 wt % to 30 wt %.

In this embodiment, the developing rollers 11 and 12 each have a cylindrical body with an outer diameter of 20 mm and a dielectric layer as described below on the peripheral surface. Both of the developing rollers 11 and 12 face to the photoreceptor 1 with a gap of 0.25 mm. Further, the photoreceptor 1 has an outer diameter of 60 mm, and the developer supply roller 10 has an outer diameter of 25 mm.

Although the developing rollers 11 and 12, and the photoreceptor 1 are not necessarily designed to have the values above, it is convenient that the developing rollers 11 and 12 have cylindrical bodies of substantially the same outer diameter and are positioned to face to the photoreceptor 1 with substantially the same gap. This facilitates the control of the electric field strengths between the photoreceptor 1 and the developing roller 11 and between the photoreceptor 1 and the developing roller 12. The control of the electric field strengths is specifically performed by selecting the relative permittivity and the thickness of the dielectric layers of the developing rollers 11 and 12. Here, “substantially the same” means that the values are within a range to generate electric field strengths that can be considered to be the same, from the viewpoint of the desired accuracy, between the photoreceptor 1 and the developing roller 11 and between the photoreceptor 1 and the developing roller 12 under a condition that the developing rollers 11 and 12 have the same dielectric layers.

The developing rollers 11 and 12 are conductive metal rollers, for example, aluminum rollers each having an alumite surface as a dielectric layer. Also, the developing rollers 11 and 12 may be rollers each having a coating of a material of which major component is fluorine resin, urethane resin or silicon resin as a dielectric layer.

In this embodiment, a condition d1/∈1>d2/∈2 is satisfied, wherein ∈1 is the relative permittivity of the first developing roller 11 that is located upstream with respect to the direction of rotation of the photoreceptor 1, d1 is the thickness of the first developing roller 11, ∈2 is the relative permittivity of the second developing roller 12 that located downstream with respect to the direction of rotation of the photoreceptor 1, and d2 is the thickness of the second developing roller 12.

Referring to Tables 1 and 2, examples 1 to 5 according to this embodiment wherein various dielectric layers were formed on the developing rollers 11 and 12 will be hereinafter described in comparison with comparative examples 1 to 5. In all the examples, each of the rollers 11 and 12 had an aluminum body with an alumite surface or a fluorine resin coating. The fluorine resin used for the coating was a mixture of silicon resin (grass-transition temperature=75 degrees C., weight-average molecular weight=530000, number average molecular weight=10000) and fluorine resin particles. This mixture was spray-coated on the roller bodies, and thereafter, the coated bodies were baked under a temperature of 300 degrees C. The thickness of the coating was 5 μm, 10 μm or 20 μm.

TABLE 1

| | Upstream | | | Downstream | | |
|---|---|---|---|---|---|---|
| | Developing Roller | | | Developing Roller | | |
| | Dielectric | d1 | d1/ε1 | Dielectric | d2 | d2/ε2 |
| | Layer | (μm) | (μm) | Layer | (μm) | (μm) |
| Example 1 | Fluorine Resin | 10 | 3.3 | Alumite | 10 | 1.3 |
| Example 2 | Fluorine Resin | 10 | 3.3 | Fluorine | 5 | 1.7 |
| | | | | Resin | | |
| Example 3 | Alumite | 20 | 2.5 | Alumite | 5 | 0.6 |
| Example 4 | Fluorine Resin | 20 | 6.7 | Alumite | 20 | 2.5 |
| Example 5 | Fluorine Resin | 10 | 3.3 | Alumite | 20 | 2.5 |
| Comparative | Fluorine Resin | 10 | 3.3 | Fluorine | 10 | 3.3 |
| Example 1 | | | | Resin | | |
| Comparative | Alumite | 10 | 1.3 | Alumite | 10 | 1.3 |
| Example 2 | | | | | | |
| Comparative | Alumite | 10 | 1.3 | Alumite | 20 | 2.5 |
| Example 3 | | | | | | |
| Comparative | Fluorine Resin | 10 | 3.3 | Fluorine | 20 | 6.7 |
| Example 4 | | | | Resin | | |
| Comparative | Alumite | 10 | 1.3 | Fluorine | 10 | 3.3 |
| Example 5 | | | | Resin | | |

TABLE 2

| | | Development Level on | | | |
|---|---|---|---|---|---|
| | | Photoreceptor (g/m²) | | Evaluation of Images | |
| | Magnitude Relation of d/ε | Upstream | Downstream | Density Unevenness | Fogging |
| Example 1 | Upstream > Downstream | 6 | 5 | A | A |
| Example 2 | Upstream > Downstream | 5.7 | 5 | A | A |
| Example 3 | Upstream > Downstream | 5.5 | 5 | A | A |
| Example 4 | Upstream > Downstream | 7 | 5 | A | B |
| Example 5 | Upstream > Downstream | 5.5 | 5 | A | B |
| Comparative | Upstream = Downstream | 2.5 | 5 | C | A |
| Example 1 | | | | | |
| Comparative | Upstream = Downstream | 2.5 | 5 | C | A |
| Example 2 | | | | | |
| Comparative | Upstream < Downstream | 2 | 5 | C | B |
| Example 3 | | | | | |
| Comparative | Upstream < Downstream | 4 | 5 | C | C |
| Example 4 | | | | | |
| Comparative | Upstream < Downstream | 3.5 | 5 | C | C |
| Example 5 | | | | | |

The relative permittivity was measured and calculated in the following way. An aluminum substrate having a resin layer with a thickness of 20 μm on its surface or an aluminum substrate having an alumite surface with a thickness of 20 μm was connected to an electrode for permittivity measurement HP16451B, and the capacitance of the substrate with a voltage of 1V at a frequency of 1 kHz applied thereto was measured by a precision LCR meter HP4284A (made by Hewlett-Packard Company). Then, the relative permittivity was calculated.

In Example 1, a fluorine resin coating with a thickness of 10 μm was formed on the first developing roller 11 (d1/∈1=3.3), and an alumite surface with a thickness of 10 μm was formed on the second developing roller 12 (d2/∈2=1.3). In Example 2, a fluorine resin coating with a thickness of 10 μm was formed on the first developing roller 11 (d1/∈1=3.3), and a fluorine resin coating with a thickness of 5 μm was formed on the second developing roller 12 (d2/∈2=1.7). In Example 3, an alumite surface with a thickness of 20 μm was formed on the first developing roller 11 (d1/∈1=2.5), and an alumite surface with a thickness of 5 μm was formed on the second developing roller 12 (d2/∈2=0.6). In Example 4, a fluorine resin coating with a thickness of 20 μm was formed on the first developing roller 11 (d1/∈1=6.7), and an alumite surface with a thickness of 20 μm was formed on the second developing roller 12 (d2/∈2=2.5). In Example 5, a fluorine resin coating with a thickness of 10 μm was formed on the first developing roller 11 (d1/∈1=3.3), and an alumite surface with a thickness of 20 μm was formed on the second developing roller 12 (d2/∈2=2.5).

In Comparative Example 1, a fluorine resin coating with a thickness of 10 μm was formed on each of the first developing roller 11 and the second developing roller 12 (d1/∈1=3.3, d2/∈2=3.3). In Comparative Example 2, an alumite surface with a thickness of 10 μm was formed on each of the first developing roller 11 and the second developing roller 12 (d1/∈1=1.3, d2/∈2=1.3). In Comparative Example 3, an alumite surface with a thickness of 10 μm was formed on the first developing roller 11 (d1/∈1=1.3), and an alumite surface with a thickness of 20 μm was formed on the second developing roller 12 (d2/∈2=2.5). In Comparative Example 4, a fluorine resin coating with a thickness of 10 μm was formed on the first developing roller 11 (d1/∈=3.3), and a fluorine resin coating with a thickness of 20 μm was formed on the second developing roller 12 (d2/∈2=6.7). In Comparative Example 5, an alumite surface with a thickness of 10 μm was formed on the first developing roller 11 (d1/∈1=1.3), and a fluorine resin coating with a thickness of 10 μm was formed on the second developing roller 12 (d2/∈2=3.3).

In Examples 1 to 5 and in Comparative Examples 1-5, printing was performed under specified fixed conditions. Table 2 shows the magnitude relation of d/∈, the development level and the evaluation of the image formed in each of the examples. With respect to the magnitude relation of die, in Examples 1-5, the upstream developing roller 11 is larger than the downstream developing roller 12. In Comparative Examples 1 and 2, the upstream developing roller 11 is equal to the downstream developing roller 12, and in Comparative Examples 3-5, the upstream developing roller 11 is smaller than the downstream developing roller 12. With respect to the development level that is indicated by g/m² of toner on a solid image portion that has passed the development area 1a or 1b, in Examples 1-5, the development level immediately after the upstream development area 1a is higher than the development level immediately after the downstream development area 1b. In Comparative Examples 1-5, the development level immediately after the upstream development area 1a is lower than the development level immediately after the downstream development area 1b.

In order to evaluate the images in the density unevenness, half-tone images were examined visually. In the column of “Density Unevenness” of Table 2, A means that the image had no density unevenness and was excellent. B means that the image had density unevenness in such a degree not to become a practical problem, and C means that the image had density unevenness in such a degree to become a practical problem. In order to evaluate the images in the fogging, backgrounds of half-tone images were examined visually. In the column of “Fogging” in Table 2, A means that the image had no fogging in the background and was excellent. B means that fogging was seen in such a degree not to become a practical problem, and C means that fogging was seen in such a degree to become a practical problem.

In Examples 1-5, d1/∈1 is larger than d2/∈2, and the development level in the upstream development area is higher than that in the downstream development area. The images formed in Examples 1-5 were evaluated to be excellent or no problem practically both in density unevenness and in fogging. In Comparative Examples 1-5, on the other hand, d1/∈1 is equal to or smaller than d2/∈2, and the development level in the upstream development area is lower than that in the downstream development. The images formed in Comparative Examples 1-5 were evaluated to be unfavorable in density unevenness, and the images formed in Comparative Examples 4 and 5 were evaluated as unfavorable in fogging.

In direct proportion to the value d/∈, the development level, that is, the quantity of toner deposited on an electrostatic latent image increases. Therefore, in Examples 1-5, because d1/∈1 is larger than d2/∈2, the quantity of toner deposited on an electrostatic latent image immediately after the electrostatic latent image passes the upstream development area 1a is larger than the quantity of toner deposited on the electrostatic latent image immediately after the electrostatic latent image passes the downstream development area 1b. When excess development of the electrostatic latent image is performed in the upstream development area 1a, the excess toner is retrieved in the downstream development area 1b. Consequently, density unevenness and fogging in low-density portions can be prevented. Also, it is possible to use a single power source for a plurality of toner support members, and the power source section can be of a simple structure.

The photoreceptor, the developer support roller and the first and the second developing rollers may not rotate necessarily in the directions described in the embodiment above. Various materials can be used for the rollers. Also, various kinds of toner and carriers can be used. The development may be either normal development or reversal development. There may be provided two developer support rollers respectively for the first developing roller and for the second developing roller.

Although the present invention has been described in connection with the preferred embodiments above, it is to be noted that various changes and modifications are possible to those who are skilled in the art. Such changes and modifications are to be understood as being within the scope of the present invention.

What is claimed is:

1. A developing device comprising:
a plurality of toner support members for supporting toner on their peripheral surfaces, the plurality of toner support members being arranged in a direction of rotation of an image support member out of contact with the image support member and including a first toner support member and a second toner support member that are located upstream and downstream, respectively, from each other with respect to the direction of rotation of the image support member; and
a developer support member for supporting a developer containing toner and carriers and supplying the toner to the plurality of toner support members;
wherein by effects of electric fields generated by potential differences between an electrostatic latent image formed on the image support member and developing biases applied to the respective toner support members, the toner supported on the plurality of toner support members moves onto the electrostatic latent image;
wherein the plurality of toner support members have dielectric layers on their surfaces, the dielectric layers satisfying a condition d1/∈1>d2/∈2, wherein the dielectric layer on the surface of the first toner support member located upstream with respect to the direction of rotation of the image support member has a relative permittivity of ∈1 and a thickness of d1, and the dielectric layer on the surface of the second toner support member located downstream with respect to the direction of rotation of the image support member has a relative permittivity of ∈2 and a thickness of d2; and
wherein the first toner support member and the second toner support member are connected to a single power source.

2. A developing device according to claim 1, wherein the first toner support member and the second toner support member have cylindrical bodies with a substantially same outer diameter and are located at a substantially same distance from the image support member.

3. A developing device according to claim 1, wherein the dielectric layers are made of a material containing fluorine resin, urethane resin or silicon resin as a major component.

4. A developing device according to claim 1, wherein the dielectric layers are alumite surfaces.

5. An image forming apparatus comprising:
an image support member;
a charger for charging a surface of the image support member;
an exposure device for irradiating the surface of the image support member with light to form an electrostatic latent image on the surface of the image support member; and
a developing device comprising:
a plurality of toner support members for supporting toner on their peripheral surfaces, the plurality of toner support members being arranged in a direction of rotation of the image support member out of contact with the image support member and including a first toner support member and a second toner support member that are located upstream and downstream, respectively, from each other with respect to the direction of rotation of the image support member;
a developer support member for supporting a developer containing toner and carriers and supplying the toner to the plurality of toner support members;
wherein by effects of electric fields generated by potential differences between the electrostatic latent image formed on the image support member and developing biases applied to the plurality of toner support members, the toner supported on the plurality of toner support members moves onto the electrostatic latent image;
wherein the plurality of toner support members have dielectric layers on their surfaces, the dielectric layers satisfying a condition d1/∈1>d2/∈2, wherein the dielectric layer on the surface of the first toner support member located upstream with respect to the direction of rotation of the image support member has a relative permittivity of ∈1 and a thickness of d1, and the dielectric layer on the surface of the second toner support member located downstream with respect to the direction of rotation of the image support member has a relative permittivity of ∈2 and a thickness of d2; and
wherein the first toner supply member and the second toner supply member are connected to a single power source.

6. An image forming apparatus according to claim 5, wherein the first toner support member and the second toner support member have cylindrical bodies with a substantially same outer diameter and are located at a substantially same distance from the image support member.

7. An image forming apparatus according to claim 5, wherein the dielectric layers are made of a material containing fluorine resin, urethane resin or silicon resin as a major component.

8. An image forming apparatus according to claim 5, wherein the dielectric layers are alumite surfaces.
